(19) United States
(12) Patent Application Publication
(10) Pub. No.: US 2023/0195843 A1
(43) Pub. Date: Jun. 22, 2023

(54) MACHINE LEARNING DEVICE, MACHINE LEARNING METHOD, AND COMPUTER PROGRAM PRODUCT

(71) Applicant: KABUSHIKI KAISHA TOSHIBA, Tokyo (JP)

(72) Inventors: Toshimitsu KANEKO, Kawasaki (JP); Kenichi SHIMOYAMA, Ota (JP); Gaku MINAMOTO, Kawasaki (JP)

(73) Assignee: KABUSHIKI KAISHA TOSHIBA, Tokyo (JP)

(21) Appl. No.: 17/822,227

(22) Filed: Aug. 25, 2022

(30) Foreign Application Priority Data
Dec. 16, 2021 (JP) 2021-204623

(51) Int. Cl. G06K 9/62; G01C 21/34; G06N 20/00

(52) U.S. Cl. CPC G06K 9/6262; G01C 21/3492; G06N 20/00

(57) ABSTRACT

A machine learning device includes an acquisition module, a first calculation module, a second calculation module, a learning module, and an output module. The acquisition module is configured to acquire observation information including information on a speed of a control target point at a control target time. The first calculation module is configured to calculate a reward for the observation information. The second calculation module is configured to calculate a corrected discount rate obtained by correcting a discount rate of the reward in accordance with a travel distance of the control target point. The learning module is configured to learn a control policy by reinforcement learning from the observation information, the reward, and the corrected discount rate. The output module is configured to output control information including information on speed control of the control target point that is determined in accordance with the observation information and the control policy.

### CROSS-REFERENCE TO RELATED APPLICATIONS

This application is based upon and claims the benefit of priority from Japanese Patent Application No. 2021-204623, filed on Dec. 16, 2021; the entire contents of which are incorporated herein by reference.

### FIELD

Embodiments described herein relate generally to a machine learning device, a machine learning method, and a computer program product.

### BACKGROUND

Attempts have been made to apply reinforcement learning to learning of various controls. Japanese Patent No. 6077617 discloses a method for learning speed control to minimize a deviation of a tool path from a command path by calculating a reward based on a deviation from the command path and performing reinforcement learning.

### BRIEF DESCRIPTION OF THE DRAWINGS

FIG. 1 is a schematic diagram of a learning system;

FIG. 2 is an illustration of a trajectory of a control target point, a target trajectory, and an error;

FIG. 3 is a functional block diagram of a machine learning device;

FIG. 4A is an illustration of error calculation based on a bead width;

FIG. 4B is an illustration of error calculation based on a penetration depth;

FIG. 5 is a schematic diagram of a display screen;

FIG. 6A is a schematic diagram of a display screen;

FIG. 6B is a schematic diagram of a display screen;

FIG. 7 is a flowchart of information processing; and

FIG. 8 is a hardware configuration diagram.

### DETAILED DESCRIPTION

According to an embodiment, a machine learning device includes an acquisition module, a first calculation module, a second calculation module, a learning module, and an output module. The acquisition module is configured to acquire observation information including information on a speed of a control target point at a control target time. The first calculation module is configured to calculate a reward for the observation information. The second calculation module is configured to calculate a corrected discount rate obtained by correcting a discount rate of the reward in accordance with a travel distance of the control target point represented by the observation information. The learning module is configured to learn a control policy by reinforcement learning from the observation information, the reward, and the corrected discount rate. The output module is configured to output control information including information on speed control of the control target point that is determined in accordance with the observation information and the control policy.

A machine learning device, a machine learning method, and a machine learning program according to embodiments will be described in detail below with reference to the accompanying drawings.

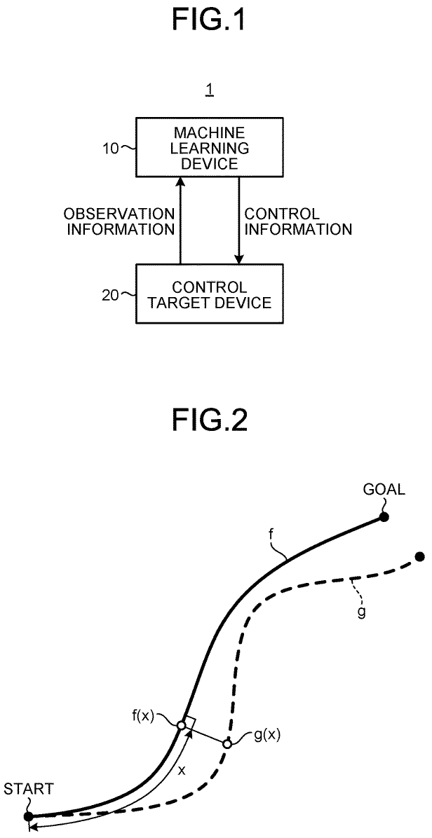

FIG. 1 is a schematic diagram of an example of a learning system 1 according to the present embodiment.

The learning system 1 includes a machine learning device 10 and a control target device 20. The machine learning device 10 and the control target device 20 are communicably connected.

The machine learning device 10 is an information processing device that performs reinforcement learning. In other words, the machine learning device 10 is an agent responsible for learning.

The control target device 20 is a control target targeted by the machine learning device 10. In other words, the control target device 20 is a target to which control information determined in accordance with a control policy learned by the machine learning device 10 is applied.

The control target device 20 is, for example, a device such as a robot such as a Cartesian coordinate robot or a multi-joint robot, a machine tool for laser machining or laser welding, and an unmanned movable body such as an unmanned vehicle or a drone. The control target device 20 may be a computer simulator that simulates the operation of such devices.

The machine learning device 10 learns a control policy so that a control target point controlled by the control target device 20 follows the same trajectory as a target trajectory. In other words, the machine learning device 10 learns a control policy that minimizes the average error of a trajectory of a control target point with respect to a target trajectory.

The control target point is a point to be controlled at each of control target times successive in a time series. When the control target device 20 is a robot, the control target point is, for example, the distal end of a robot arm or a specific position of an end effector. When the control target device 20 is a machine tool for laser machining or laser welding, the control target point is, for example, a laser radiation point in laser machining. When the control target device 20 is an unmanned movable body such as an unmanned vehicle or a drone, the control target point is, for example, the center of gravity of the unmanned movable body.

In reinforcement learning, the learning of the machine learning device 10 proceeds through the interaction between the machine learning device 10 responsible for learning and the control target device 20 to be controlled.

Specifically, the control target device 20 outputs observation information on a state of a control target point at a control target time to the machine learning device 10. The machine learning device 10 determines control information representing an action in accordance with the observation information acquired from the control target device 20 and a control policy and outputs the control information to the control target device 20. A series of these processes is repeated, so that the learning of the machine learning device 10 proceeds.

The observation information is information that represents a state of a control target point at a control target time and is necessary for controlling the control target device 20. In the present embodiment, the observation information at least includes information on the speed of a control target point at a control target time.

The information on the speed of a control target point may be any information that can specify the speed of a control target point at a control target time. Specifically, the information on the speed of a control target point is information that represents at least one of the position, the speed, and the acceleration of a control target point at a control target time.

The control information is information used for controlling the action of a control target point. In the present embodiment, the control information at least includes information on speed control of a control target point.

Specifically, when the control target device 20 is a drone, the control information is, for example, the speed or the acceleration in each direction of the forward, backward, left, right, up, and down, and the observation information is information necessary for controlling the drone, such as information on the position, the speed, and the surroundings of the drone. The information on the surroundings is, for example, an image of surroundings captured by a camera, a distance image, an occupancy grid map, and the like.

When the control target device 20 is a multi-joint robot, the control information is the torque and the angle of each joint, and the position, posture, and speed of the control target point. The observation information is information necessary for controlling the multi-joint robot, such as the angle and the angular speed of each joint, the position, posture, and speed of the control target point, and information on the work environment. The information on the work environment is, for example, an image of surroundings captured by a camera, a distance image, and the like.

When the control target device 20 is a laser welding machine, the control information is welding speed, welding acceleration, laser power, spot diameter, and the like. The observation information is information necessary for controlling the laser welding machine, such as a laser radiation position, a radiation speed, a spot diameter, the gap between materials, the width of bead or molten pool, and information on the vicinity of a weld position. The information on the vicinity of a weld position is, for example, an image of the surroundings of a weld position captured by a camera, a temperature distribution, and the like.

The basic concepts of reinforcement learning will now be described.

Reinforcement learning is a method of learning a control policy that determines an action at from a state sₜ input at certain control target time t.

The state sₜ corresponds to the observation information or a part thereof at the control target time t. The action at corresponds to the control information.

The control policy is a probability distribution expressed by n(aₜ|sₜ). The control policy n(aₜ|sₜ) is learned, for example, by a neural network that outputs probability values or parameters of a probability model.

Reinforcement learning aims to learn a control policy n(aₜ|sₜ) that maximizes the expected value of the discounted cumulative reward given by the following Formula (1). The discounted cumulative reward is the sum of rewards earned since the present time, multiplied by a weight that is smaller as the time difference from the present time is greater.

$${\sum }_{k = 0}^{∞} {γ}^{k} r ( {s}_{t + k} , {a}_{t + k} ) \qquad ( 1 )$$

In Formula (1), r(Sₜ, aₜ) represents the reward calculated at time t+1 as a result of the action aₜ taken in the state sₜ. In Formula (1), γ is a discount rate. k is an integer equal to or greater than 0.

The discount rate γ is a parameter of 0 through 1, both inclusive, for adjusting how much the reward in the distant future is taken into consideration to determine an action. In other words, the discount rate γ is a hyperparameter for adjusting how distant future is taken into consideration. A parameter for evaluating the reward earned in more distant future at a greater discount is used for the discount rate γ. The discount rate γ also serves as regularization to stabilize learning.

Various algorithms are known for reinforcement learning. Many of them include learning steps of a value function V(sₜ) and an action value function Q(sₜ, aₜ).

The value function V(sₜ) is the estimated value of the discounted cumulative reward earned by acting from the state sₜ in accordance with the present control policy n(aₜ|sₜ). The value function V(sₜ) is learned by an updating formula given by the following Formula (2) in a method called temporal difference (TD) learning.

V(sₜ)←V(sₜ)+α[r(sₜ,aₜ)+γV(sₜ₊₁)−V(sₜ)] (2)

In Formula (2), α is a learning rate.

The action value function Q(sₜ, aₜ) is the estimated value of the discounted cumulative reward earned by acting in accordance with the present control policy n(aₜ|sₜ) after taking the action at in the state sₜ. The action value function Q(sₜ, aₜ) is learned by an updating formula given by the following Formula (3) in TD learning.

Q(sₜ,aₜ)←Q(sₜ,aₜ)+α[r(sₜ,aₜ)+γ∫π(a|sₜ₊₁)Q(sₜ₊₁,a)da−Q(sₜ,aₜ)] (3)

In Formula (3), the following Expression (4) below is generally difficult to calculate.

∫π_{θ}(a|sₜ₊₁)Q(sₜ₊₁,a)da (4)

For this reason, instead of Expression (4) in Formula (3), the value function V(sₜ) is used, or the action value function Q(sₜ₊₁, aₜ) with only actions a sampled in accordance with the control policy n(a|sₜ₊₁) is used.

The value function V(sₜ) and the action value function Q(sₜ, aₜ) are learned, for example, with a linear model or a neural network.

To learn a control policy that makes the trajectory of the control target point as close as possible to the target trajectory by reinforcement learning, it is necessary to learn using a reward that reflects the error with respect to the target trajectory.

For example, learning may be performed using, as a reward r(sₜ, aₜ), the integral of the error of the trajectory of the control target point from the control target time t to the control target time t+1, or the average value of the trajectory of the control target point multiplied by −1.

However, when the speed of the control target point is a control target, the value of the discounted cumulative reward varies not only with the error but also with the speed. The conventional art therefore does not always minimize the average error.

For example, when a reward that is the integral of the error of the trajectory multiplied by −1 is used, the power of the discount rate increases, because as the speed decreases, the passage of time increases, and the negative reward is discounted heavily and the discounted cumulative reward increases. Therefore, even when the error can be reduced by increasing the speed, a control policy that decreases the speed to increase the discounted cumulative reward may be learned. On the other hand, when a reward that is the average of the error of the trajectory multiplied by −1 is used, the number of negative rewards added decreases as the speed increases, and the discounted cumulative reward increases. Therefore, a control policy that increases the speed to increase the discounted cumulative reward may be learned.

As described above, in the conventional reinforcement learning, it is difficult to minimize the average error of the trajectory of the control target point with respect to the target trajectory when a control policy for the control target point including speed control is learned by reinforcement learning.

In the machine learning device 10 of the present embodiment, instead of the discount rate of the reward, the corrected discount rate obtained by correcting the discount rate of the reward in accordance with the travel distance of the control target point is used to learn a control policy by reinforcement learning. By using the corrected discount rate, the machine learning device 10 of the present embodiment can prevent change in speed from influencing the value of the discounted cumulative reward and can learn a control policy that minimizes the average error.

FIG. 2 is an illustration of an example of the trajectory of the control target point, the target trajectory, and the error.

FIG. 2 illustrates a target trajectory f from a start position to a goal position, and a position f(x) on the target trajectory f. The position f(x) is a position on the target trajectory f and represents the position of a distance x along the target trajectory f from the start position. A trajectory g of the control target point is the trajectory actually followed by the control target point. The intersection of the perpendicular or the vertical plane to the target trajectory f passing through the position f (x) and the trajectory g of the control target point is denoted as a position g(x). In general, a plurality of the intersections may be present. In the present embodiment, it is assumed that the target trajectory f and the trajectory g of the control target point are sufficiently similar in shape, and the position g(x) of the intersection is uniquely determined.

Furthermore, the distance x when the position of the control target point at the control target time t is the position g(x) is denoted as xₜ. In other words, g(xₜ) is the position of the control target point at time t and, at the same time, is the intersection of g and the straight line orthogonal to f passing through the position at the distance xₜ along the target trajectory f from the start position.

The machine learning device 10 of the present embodiment learns such that the corrected discounted cumulative reward obtained by correcting the discounted cumulative reward is maximized. The corrected discounted cumulative reward is given by Formula (5) below.

$${\sum }_{k = 0}^{∞} {γ}^{{x}_{t + k} - {x}_{t}} r ( {s}_{t + k} , {a}_{t + k} ) \qquad ( 5 )$$

Here, the error at the position f(x) on the target trajectory f is denoted as d(x). The error d(x) is the Euclidean distance between the position f(x) and the position g(x). In this case, the reward r(sₜ, aₜ) is given by the following Formula (6).

$$r ( {s}_{t} , {a}_{t} ) = - {\int }_{{x}_{t}}^{{x}_{t + 1}} {γ}^{x - {x}_{t}} d ( x ) dx \qquad ( 6 )$$

Then, the corrected discounted cumulative reward given by Formula (5) above is written as Formula (7) below.

$$- {\int }_{{x}_{t}}^{∞} {γ}^{x - {x}_{t}} d ( x ) dx \qquad ( 7 )$$

As denoted by Formula (7), the corrected discounted cumulative reward given by Formula (7) is a value not influenced by the speed and determined solely by the error. Thus, a control policy that minimizes the average error can be learned even in learning of a control policy for determining control information including information on speed control.

The reward may be defined using various approximations. For example, when the interval between the control target times is sufficiently short, the reward may be defined by Formula (8) below.

r(sₜ,aₜ)=−(xₜ₊₁−xₜ)d(xₜ) (8)

In the present embodiment, in order to maximize the corrected discounted cumulative reward, an updating formula given by the following Formula (9) is used in TD learning of the value function V(sₜ).

V(sₜ)←V(sₜ)+α[r(sₜ,aₜ)+γ^{x}^{ₜ₊₁}^{-x}^{ₜ}V(sₜ₊₁)−V(sₜ)] (9)

In the present embodiment, an updating formula given by the following Formula (10) is used in TD learning of the action value function Q(sₜ, aₜ).

Q(sₜ,aₜ)←Q(sₜ,aₜ)+α[r(sₜ,aₜ)+γ^{x}^{ₜ₊₁}^{-x}^{ₜ}∫π(a|sₜ₊₁)Q(sₜ₊₁,a)da−Q(sₜ,aₜ)] (10)

In other words, in the machine learning device 10 of the present embodiment, the discount rate γ in Formula (2) or (3) above is corrected, and the corrected discount rate given by the following Formula (11) is used to apply the updating formula for the value function and the action value function.

γ^{x}^{ₜ₊₁}^{-x}^{ₜ} (11)

In other words, in the machine learning device 10 of the present embodiment, instead of the discount rate, the corrected discount rate given by Formula (11) obtained correcting the discount rate of the reward in accordance with the travel distance of the control target point is used to learn a control policy by reinforcement learning. By using the corrected discount rate, the machine learning device 10 of the present embodiment can learn a control policy that minimizes the average error.

The configuration of the machine learning device 10 in the present embodiment will now be described in detail.

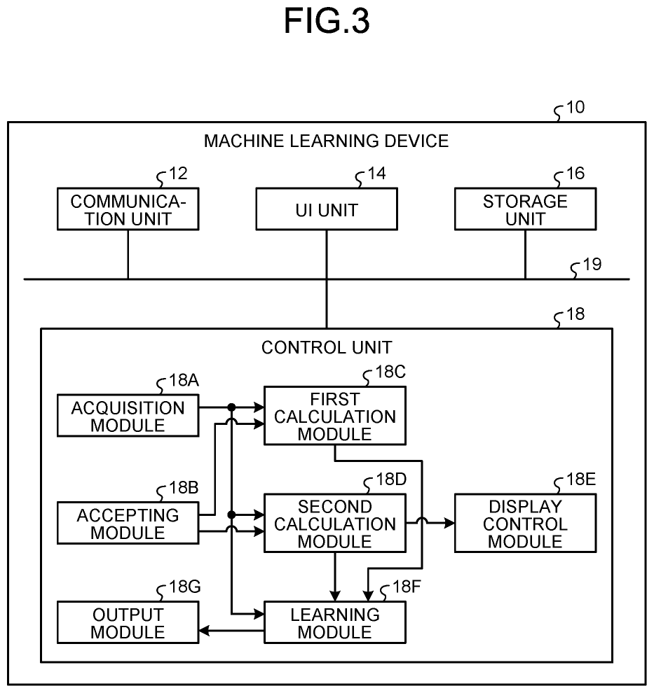

FIG. 3 is a functional block diagram of an example of the machine learning device 10 of the present embodiment.

The machine learning device 10 includes a communication unit 12, a user interface (UI) unit 14, and a storage unit 16. The communication unit 12, the UI unit 14, the storage unit 16, and a control unit 18 are communicably connected via a bus 19 or the like.

The communication unit 12 communicates with an external information processing device such as the control target device 20 via a network or the like. The UI unit 14 has a display function and an input function. The display function displays various kinds of information. The display function is, for example, a display, a projector, and the like. The input function accepts an operation input by the user. The input function is, for example, a pointing device such as a mouse and a touchpad, and a keyboard. The display function and the input function may be integrally formed as a touch panel. The storage unit 16 stores therein various kinds of information.

The UI unit 14 and the storage unit 16 are communicably connected to the control unit 18 by wire or by radio. At least one of the UI unit 14 and the storage unit 16 may be connected to the control unit 18 via a network or the like.

At least one of the UI unit 14 and the storage unit 16 may be provided outside of the machine learning device 10. At least one of one or more functions included in the UI unit 14, the storage unit 16, and the control unit 18 may be installed in an external information processing device communicably connected to the machine learning device 10 via a network or the like.

The control unit 18 performs information processing in the machine learning device 10. The control unit 18 includes an acquisition module 18A, an accepting module 18B, a first calculation module 18C, a second calculation module 18D, a display control module 18E, and a learning module 18F. The acquisition module 18A, the accepting module 18B, the first calculation module 18C, the second calculation module 18D, the display control module 18E, and the learning module 18F are implemented by, for example, one or more processors. For example, the above modules may be implemented by allowing a processor such as a central processing unit (CPU) to execute a computer program, that is, by software. The above modules may be implemented by a processor such as a dedicated IC, that is, by hardware. The above modules may be implemented by a combination of software and hardware. When a plurality of processors are used, each processor may implement one of the modules or may implement two or more of the modules.

The acquisition module 18A acquires observation information. As described above, the observation information is information that represents a state of a control target point at a control target time and includes information on the speed of a control target point at a control target time. The acquisition module 18A sequentially acquires the observation information sequentially output from the control target device 20 for each control target time. Every time the acquisition module 18A acquires observation information at a control target time, the acquisition module 18A outputs the acquired observation information to each of the first calculation module 18C, the second calculation module 18D, and the learning module 18F.

The accepting module 18B accepts an operation instruction on the UI unit 14 by the user.

The first calculation module 18C calculates a reward for the observation information accepted from the acquisition module 18A.

The first calculation module 18C calculates the error d(x) (first error) between the control target point and the target trajectory, using information on the position of the control target point included in the observation information, and calculates the reward higher as the error d(x) is smaller.

More specifically, first, the first calculation module 18C calculates the error d(x) between the target trajectory f and the position g(x) of the control target point from the observation information accepted from the acquisition module 18A. Subsequently, the first calculation module 18C calculates the reward from the error d(x) and outputs the reward to the learning module 18F.

For example, when the control target device 20 is a drone or a multi-joint robot, the Euclidean distance given by the following Formula (12) or the square of the Euclidean distance given by the following Formula (13) is used in calculation of the error d(x).

d(x)=∥g(x)−f(x)∥ (12)

d(x)=∥g(x)−f(x)∥² (13)

When the control target device 20 is a laser processing machine or a laser welding machine, the Euclidean distance given by Formula (12) above or the square of the Euclidean distance given by Formula (13) above may be used in calculation of the error d(x), in the same manner as for a drone or a multi-joint robot.

When the control target device 20 is a laser welding machine, the error d(x) may be calculated based on a bead width, a penetration depth, and the like.

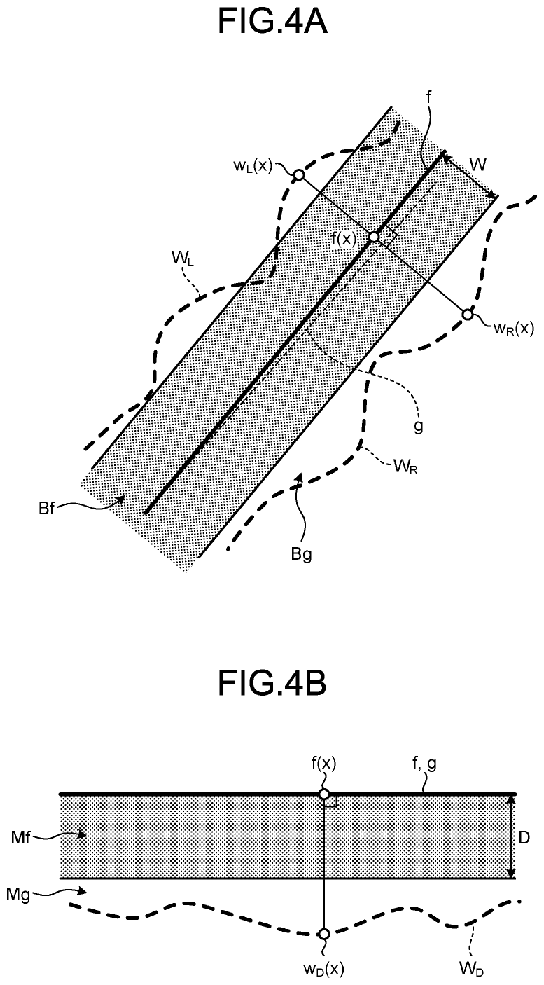

FIG. 4A is an illustration of an example of calculation of the error d(x) based on a bead width.

In FIG. 4A, a trajectory W_{R} and a trajectory WL are the trajectories of end portions of a bead or molten pool region Bg formed by laser welding along the trajectory g of the control target point. In FIG. 4A, the intersections of the vertical plane to the target trajectory f passing through the position f(x) on the target trajectory f of laser radiation and the trajectory W_{R} and the trajectory WL are denoted as intersection W_{R}(x) and intersection WL(x), respectively.

A length W is half the width of a bead or molten pool region Bf when laser welding is performed under the targeted control along the target trajectory f. Then, the error d(x) of the bead width of the bead or molten pool region Bg formed by laser welding along the trajectory g of the control target point, with respect to the region Bf, can be defined as the following Formula (14) or (15).

d(x)=|∥w_{R}(x)−w_{L}(x)∥−2W| (14)

d(x)=|∥w_{R}(x)−w_{L}(x)∥−2W|² (15)

In consideration of the center misalignment in addition to the bead width, the error d(x) of the bead width may be defined as the following Formula (16) or (17).

d(x)=|∥w_{R}(x)−f(x)∥−W|+|∥w_{L}(x)−f(x)∥−W| (16)

d(x)=|∥w_{R}(x)−f(x)∥−W|²+|∥w_{L}(x)−f(x)∥−W|² (17)

In this way, when the control target device 20 is a laser welding machine, the first calculation module 18C may calculate the error d(x) based on the bead width.

FIG. 4B is an illustration of an example of calculation of the error d(x) based on a penetration depth.

In FIG. 4B, a trajectory W_{D} is the trajectory of penetration depth of a penetration region Mg formed by laser welding along the trajectory g of the control target point. In FIG. 4B, the intersection of the vertical plane to the target trajectory f passing through the position f(x) on the target trajectory f of laser welding and the trajectory W_{D} is denoted as an intersection W_{D}(x), and a penetration depth of the targeted penetration region Mf is denoted as a penetration depth D.

Then, the error d(x) of the penetration depth expressed by the trajectory W_{D} with respect to the target penetration depth D can be defined as the following Formula (18) or (19).

d(x)=|∥w_{D}(x)−f(x)∥−D| (18)

d(x)=|∥w_{D}(x)−f(x)∥−D|² (19)

In this way, when the control target device 20 is a laser welding machine, the first calculation module 18C may calculate the error d(x) based on the penetration depth.

It is assumed that the observation information at least includes information on the speed of a control target point at a control target time and includes these pieces of information necessary for calculating the error d(x). The first calculation module 18C therefore can calculate the error d(x) between the target trajectory f and the position g(x) of the control target point from the observation information accepted from the acquisition module 18A.

Here, the error d(x) is sometimes unable to be calculated directly from the observation information. In this case, the first calculation module 18C may calculate the error d(x) after performing preprocessing necessary for the error calculation.

For example, assume that the error (x) based on the bead width is calculated from an image in the vicinity of a weld position. In this case, the bead width may be calculated by estimating the bead or molten pool region by image processing or image recognition processing.

Subsequently, the first calculation module 18C calculates the reward for use in reinforcement learning, using the calculated error d(x).

For example, at the control target time t, the first calculation module 18C calculates the reward for an action aₜ₋₁ at control target time t−1 one time earlier, using the following Formula (20).

$$r ( {s}_{t - 1} , {a}_{t - 1} ) = - {\int }_{{x}_{t - 1}}^{{x}_{t}} {γ}^{x - {x}_{t - 1}} d ( x ) dx \qquad ( 20 )$$

The first calculation module 18C may calculate the reward using the following Formula (21), which is an approximation of Formula (20) above.

r(sₜ₋₁,aₜ₋₁)=−(xₜ−xₜ₋₁)d(xₜ₋₁) (21)

The first calculation module 18C may perform postprocessing, such as scaling by an appropriate constant or clipping with a lower limit, for the reward calculated by Formula (20) or (21) above.

The first calculation module 18C then outputs the calculated reward to the learning module 18F.

The error d(x) in the vicinity of the control target point is not always determined immediately, for example, due to delays caused by data communication and processing time or change in molten pool in welding. In such a case, the first calculation module 18C may perform the following process.

For example, the first calculation module 18C sets the error calculation target position to a position away from the position of the control target point represented by the observation information by a certain distance L or more in a retrospective direction in a time series along the trajectory g of the control target point. The first calculation module 18C then may calculate the error (second error) between the target trajectory f and the error calculation target position as the error d(x) that is a first error.

In this case, the first calculation module 18C can calculate the reward according to the following Formula (22) or (23).

$$r ( {s}_{t - 1} , {a}_{t - 1} ) = - {\int }_{{x}_{t - 1}}^{{x}_{t}} {γ}^{x - {x}_{t - 1}} d ( x - L ) dx \qquad ( 22 )$$

$$r ( {s}_{t - 1} , {a}_{t - 1} ) = - ( {x}_{t} - {x}_{t - 1} ) d ( {x}_{t - 1} - L ) \qquad ( 23 )$$

For example, the first calculation module 18C sets the error calculation target position to a position away from the position of the control target point represented by the observation information by a certain time period T or more in a retrospective direction in a time series along the trajectory g of the control target point. The first calculation module 18C then may calculate the error (second error) between the target trajectory f and the error calculation target position as the error d(x) that is a first error.

In this case, the first calculation module 18C delays the error calculation and the output of the reward to the learning module 18F by storing the observation information for the time period T into a buffer, the storage unit 16, or the like until calculation of the error d(x) becomes possible. The first calculation module 18C can calculate the reward the time period T earlier when the error calculation becomes possible, according to the following Formula (24).

r(s_{t-T-1},a_{t-T-1}) (24)

The margin that is the certain distance L and the delay time that is the certain time period T may be stored in the storage unit 16 in advance. Then, the first calculation module 18C can perform the above calculation by reading the certain distance L or the certain time period T from the storage unit 16.

The margin that is the certain distance L and the delay time that is the certain time period T may be input by the user.

In this case, the display control module 18E displays, for example, a display screen on the UI unit 14 to accept input of at least one of the margin and the delay time. In this case, the UI unit 14 functions as an input/output device for the user to input or confirm the parameters necessary for the error calculation and the corrected discount rate calculation.

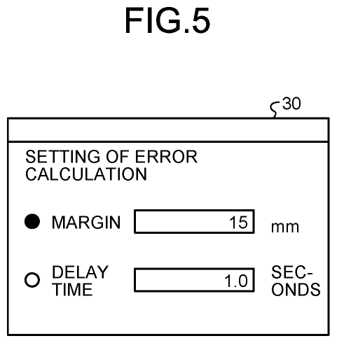

FIG. 5 is a schematic diagram of an example of a display screen 30. The display screen 30 includes entry fields for the margin and the delay time. The user can input the margin that is a desired certain distance L or the delay time that is a desired certain time period T by operating the UI unit 14 while viewing the display screen 30. More specifically, for example, a radio button for the margin in the display screen 30 is turned on and a value representing the margin is input, whereby the margin that is the certain distance L desired by the user is input. For example, a radio button for the delay time in the display screen 30 is turned on and a value representing the delay time is input, whereby the delay time that is the certain time period T desired by the user is input.

Upon input of the margin or the delay time through an operation instruction on the UI unit 14 by the user, the accepting module 18B accepts the margin or the delay time input by the user.

The first calculation module 18C may calculate the reward by performing the above calculation using a certain distance L that is the margin, input of which has been accepted, or a certain time period T that is the delay time, input of which has been accepted.

By using the certain distance L or the certain time period T, input of which has been accepted from the user, the first calculation module 18C can calculate the reward in accordance with change in conditions of the control target device 20.

For example, when the conditions of the control target device 20, such as the environment of the unmanned movable body or the robot, or the material of the laser welding, change, the appropriate margin and the appropriate delay time may also change. Since the margin or the delay time can be set and changed by the user, the first calculation module 18C can calculate the reward in accordance with the conditions of the control target device 20.

Returning to FIG. 3, the description will be continued. The second calculation module 18D calculates the corrected discount rate obtained by correcting the discount rate of the reward in accordance with the travel distance of the control target point represented by the observation information.

The travel distance is the distance measured along the target trajectory f between the positions g(x) of the control target point indicated by the observation information at two different control target times. Specifically, the travel distance is expressed by xₜ−xₜ₋₁. In other words, the travel distance is expressed by the absolute value of the difference between the distance xₜ from the start position on the foot of the perpendicular descending from the position g(x) on the trajectory g of the control target point to f at a control target time t and the distance xₜ₋₁ from the start position on the foot of the perpendicular descending from the position g(x) on the trajectory g of the control target point to f at a control target time t−1 different from the control target point.

The second calculation module 18D calculates, as the corrected discount rate, the power of the discount rate γ with the travel distance xₜ−xₜ₋₁ as the exponent of the power. In other words, the second calculation module 18D calculates the corrected discount rate at the control target time t according to the following Formula (25).

γ^{x}^{ₜ}^{-x}^{_{t−1}} (25)

The second calculation module 18D may calculate the discount rate from an input corrected discount rate and an input travel distance input by the user and calculate the corrected discount rate using this discount rate.

The user may directly input the input corrected discount rate by operating the UI unit 14, but it is difficult to intuitively understand how much the reward is discounted. It is therefore preferable that the display control module 18E display a display screen on the UI unit 14 so that the input corrected discount rate can be set more intuitively.

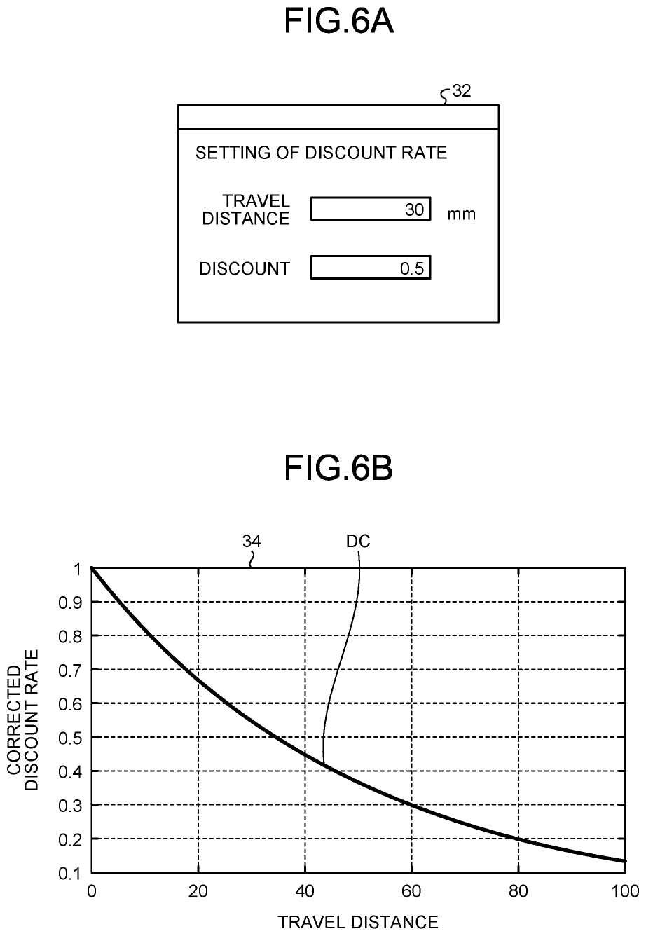

FIG. 6A is a schematic diagram of an example of a display screen 32. The display control module 18E displays the display screen 32 on the UI unit 14. The display screen 32 includes an entry field for the input travel distance and an entry field for the input corrected discount rate (labeled as “discount” in the display screen 32). The entry fields for the input travel distance as well as the input corrected discount rate indicate how much the reward is discounted for the travel distance, thereby enabling the user to input the input corrected discount rate more intuitively.

By operating the UI unit 14 while viewing the display screen 32, the user inputs the input travel distance and the input corrected discount rate, which is the rate at which the error and the reward are discounted in the input travel distance.

Assume a situation in which the user inputs an input travel distance X and an input corrected discount rate G desired by the user for the input travel distance X through an operation instruction on the UI unit 14.

In this case, the second calculation module 18D calculates the discount rate γ from the input corrected discount rate G at the input travel distance X, according to the following Formula (26).

$$γ = {G}^{\frac{1}{X}} \qquad ( 26 )$$

The second calculation module 18D then may calculate the corrected discount rate by correcting the discount rate γ calculated according to Formula (26) in accordance with the travel distance, in the same manner as described above.

For confirmation, the display control module 18E may display, on the UI unit 14, correspondence information that represents the correspondence between the corrected discount rate calculated by the second calculation module 18D and the travel distance.

FIG. 6B is a schematic diagram of an example of a display screen 34. For example, the display control module 18E displays the display screen 34 on the UI unit 14. The display screen 34 includes a graph including a line DC representing the correspondence between the corrected discount rate and the travel distance as the correspondence information. The correspondence information is not limited to a graph and may be any information that represents the correspondence between the corrected discount rate and the travel distance.

In this way, the second calculation module 18D may calculate the discount rate from the input corrected discount rate and the input travel distance input by the user and calculate the corrected discount rate by correcting this discount rate with the travel distance. When the conditions of the control target device 20, such as the environment of the unmanned movable body or the robot, or the material of the laser welding, change, the appropriate discount rate may also change. Since the discount rate can be set and changed by the user, the second calculation module 18D can calculate the corrected discount rate in accordance with the conditions of the control target device 20.

The second calculation module 18D then outputs the calculated corrected discount rate to the learning module 18F.

Returning to FIG. 3, the description will be continued. The learning module 18F learns a control policy by reinforcement learning from the observation information accepted from the acquisition module 18A, the reward accepted from the first calculation module 18C, and the corrected discount rate accepted from the second calculation module 18D.

In other words, the learning module 18F learns a control policy that minimizes the average error of the trajectory g of the control target point with respect to the target trajectory f, by reinforcement learning, using the observation information, the reward, and the corrected discount rate.

More specifically, the learning module 18F determines control information including information on speed control of the control target point, from the observation information including information on the speed of the control target point at a control target time accepted from the acquisition module 18A. The learning module 18F learns a control policy from the observation information accepted from the acquisition module 18A, the reward accepted from the first calculation module 18C, and the corrected discount rate accepted from the second calculation module 18D.

First, the learning module 18F performs processing such as extraction of some pieces of data, scaling, and clipping for the observation information at the control target time t accepted from the acquisition module 18A to convert the observation information into a state sₜ for use in reinforcement learning. When the observation information includes an image, the learning module 18F may perform image processing or image recognition processing in the same way as the first calculation module 18C does.

Subsequently, the learning module 18F determines an action at using the present control policy for the observation information at the control target time t accepted from the acquisition module 18A. For example, the learning module 18F samples actions at in accordance with the control policy n(aₜ|sₜ) represented by a probability distribution. The learning module 18F may randomly sample actions at without using the control policy n(aₜ|sₜ) for a period of a certain number of times from the start.

The learning module 18F outputs the action at determined by these processes to an output module 18G.

The learning module 18F stores the data used for learning as experience data in the storage unit 16. The learning module 18F learns a control policy based on the experience data. More specifically, the learning module 18F stores the experience data into the storage unit 16, in which at least the corrected discount rate and the reward of the observation information used to calculate the corrected discount rate are associated with each other. Specifically, the learning module 18F stores the experience data for each control target time t in the storage unit 16. The experience data includes the state, the action, the reward, and the corrected discount rate, given by Expression (27) below.

State: sₜ₋₁

Action: aₜ₋₁

Reward: r(sₜ₋₁,aₜ₋₁)

Corrected discount rate: γ^{x}^{ₜ}^{-x}^{_{t−1}} (27)

Depending on the reinforcement learning algorithm used, the learning module 18F may also include the state, the value of the value function, the value of the action value function, the action, the probability value of the action, and the like given by the following Expression (28) in the experience data.

State: sₜ

Value function: V(sₜ)

Action value function: Q(sₜ,aₜ)

Action: aₜ

Probability value of the action: π(aₜ₋₁|sₜ₋₁) (28)

The learning module 18F further performs a process of updating the control policy n(aₜ|sₜ), the value function V(sₜ), and the action value function Q(sₜ, aₜ) at a certain frequency.

When a reinforcement learning algorithm called an on-policy method is used, the learning module 18F may extract all pieces of the experience data to perform the updating process at a timing, such as a timing when a certain number of pieces of experience data is stored in the storage unit 16, or a timing when the flying of the drone or the welding is finished.

On the other hand, when a reinforcement learning algorithm called an off-policy method is used, the learning module 18F may sample a certain number of pieces of experience data from the storage unit 16 every time or once a few times to perform the updating process. In the off-policy method, the experience data may be stored in the storage unit 16 until a predetermined maximum number of pieces of experience data is reached, and when the maximum number is exceeded, the earliest experience data may be discarded.

The learning module 18F can use any reinforcement learning algorithm to update the control policy, the value function, and the action value function. However, in the present embodiment, the learning module 18F performs the updating process for them, using the corrected discount rate accepted from the second calculation module 18D, instead of the discount rate. For example, when at least one of the value function V(sₜ) and the action value function Q(sₜ, aₜ) is learned by TD learning, the learning module 18F updates the value function V(sₜ) and the action value function Q(sₜ, aₜ) using Formulas (9) and (10) above.

The learning module 18F performs the process in accordance with the reinforcement learning algorithm used, except that the corrected discount rate is used instead of the discount rate.

The output module 18G will now be described.

The output module 18G outputs control information including information on speed control of the control target point that is determined in accordance with the observation information and the control policy. More specifically, the output module 18G accepts an action at from the learning module 18F. The output module 18G converts the action at into control information by performing processing such as scaling for the action aₜ accepted from the learning module 18F, and outputs the control information to the control target device 20.

An example of the information processing performed by the machine learning device 10 of the present embodiment will now be described.

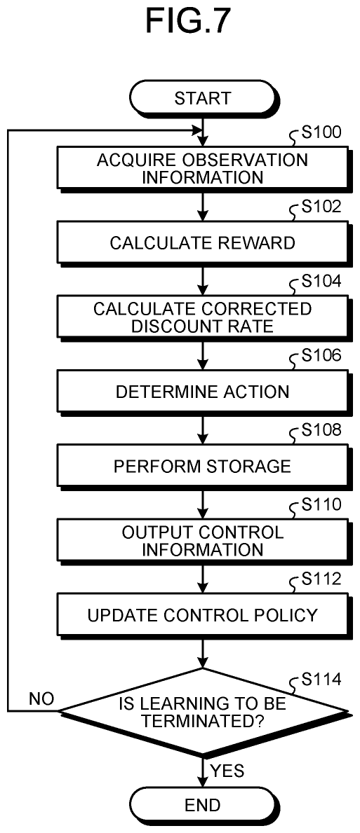

FIG. 7 is a flowchart illustrating an example flow of the information processing performed by the machine learning device 10 of the present embodiment.

The acquisition module 18A acquires the observation information at control target time t from the control target device 20 (step S100).

The first calculation module 18C calculates a reward r(sₜ₋₁, aₜ₋₁) from the observation information acquired at step S100 (step S102).

The second calculation module 18D calculates the corrected discount rate from the observation information acquired at step S100 (step S104). The corrected discount rate is given by Formula (11) above.

The learning module 18F determines an action at from the observation information acquired at step S100 (step S106).

The learning module 18F stores experience data including the reward r(sₜ₋₁, aₜ₋₁) calculated at step 102, the corrected discount rate calculated at step S104, an action aₜ₋₁ previously determined at step S106, and a state sₜ₋₁ into the storage unit 16 (step S108).

The output module 18G converts the action at determined at step S106 into control information and outputs the control information to the control target device 20 (step S110).

The learning module 18F determines whether it is the timing to perform the updating process of updating the control policy n(aₜ|sₜ), the value function V(sₜ), and the action value function Q(sₜ, aₜ). If it is determined that it is the timing to perform the updating process, the learning module 18F reads the experience data from the storage unit 16 and performs the updating process of updating the control policy n(aₜ|sₜ), the value function V(sₜ), and the action value function Q(sₜ, aₜ) (step S112). At step S112, the learning module 18F performs the updating process using the corrected discount rate included in the experience data read from the storage unit 16, instead of the discount rate.

Subsequently, the learning module 18F determines whether to terminate the learning (step S114). The learning module 18F determines to terminate the learning when the updating process is performed a certain number of times, when the amount of change in the control policy n(aₜ|sₜ), the value function V(sₜ), or the action value function Q(sₜ, aₜ) by the updating process becomes equal to or less than a certain value, when the learning takes a certain time or longer, or when a termination instruction is input by the user. If the learning module 18F determines to continue the learning (No at step S114), the process returns to step S100 above and the process is repeated for the next control target time t+1. If the learning module 18F determines to terminate the learning (Yes at step S114), this routine is terminated.

As described above, the machine learning device 10 of the present embodiment includes the acquisition module 18A, the first calculation module 18C, the second calculation module 18D, the learning module 18F, and the output module 18G. The acquisition module 18A acquires observation information including information on the speed of the control target point at a control target time. The first calculation module 18C calculates the reward for the observation information. The second calculation module 18D calculates the corrected discount rate obtained by correcting the discount rate of the reward in accordance with the travel distance of the control target point represented by the observation information. The learning module 18F learns the control policy from the observation information, the reward, and the corrected discount rate by reinforcement learning. The output module 18G outputs control information including information on speed control of the control target point that is determined in accordance with the observation information and the control policy.

Defining the control of robots, machine tools, unmanned movable bodies, and the like for each of the various conditions is a time-consuming task that requires much knowledge and experience. Moreover, the design of manual control is based on experience and is not always optimal control. The reinforcement learning capable of autonomously learning optimal control by the trial-and-error approach is being attempted to be applied to learning of various types of control.

For example, the reinforcement learning can be used to learn such a control method that a control target point such as a distal end of a robot arm, a machining point of a machine tool, or the center of gravity of an unmanned vehicle or a drone follows a trajectory with minimized errors with respect to the target trajectory.

The conventional art discloses a method for learning speed control to minimize a deviation of a tool path from a command path by calculating a reward based on a deviation from the command path and performing reinforcement learning. The conventional art discloses a method for learning welding control including welding speed by reinforcement learning in laser welding by calculating a reward based on the difference between the desired bead width and the generated bead width.

Reinforcement learning is a technique for learning a policy that maximizes the expected value of the discounted cumulative reward. As described above, the discounted cumulative reward is the sum of the rewards earned since the present time, multiplied by a weight that is smaller as the time difference from the present time is greater. As disclosed in the conventional arts, a control method that reduces errors can be learned by performing reinforcement learning using rewards calculated based on errors.

However, when the speed of the control target point is a control target, the time difference during movement over a certain distance varies with speed and, therefore, the discounted cumulative error varies not only with the error but also with the speed. In other words, when reinforcement learning is performed by calculating the reward from the error of the trajectory g of the control target point with respect to the target trajectory f, the value of the discounted cumulative reward changes with the speed and, therefore, the speed control that minimizes the average error is not always learned. For this reason, with the conventional arts, it is difficult to minimize the average error of a trajectory of a control target point including speed control with respect to a target trajectory.

On the other hand, in the machine learning device 10 of the present embodiment, the learning module 18F learns a control policy by reinforcement learning, using the corrected discount rate obtained by correcting the discount rate in accordance with the travel distance of the control target point, instead of the discount rate. With the corrected discount rate, the discounted cumulative reward is the function only of the error and is not influenced by the speed, so that the control policy that minimizes the average error can be learned.

The machine learning device 10 of the present embodiment therefore can minimize the average error of the trajectory g of the control target point including the speed control with respect to the target trajectory f.

An example of the hardware configuration of the machine learning device 10 of the foregoing embodiment will now be described.

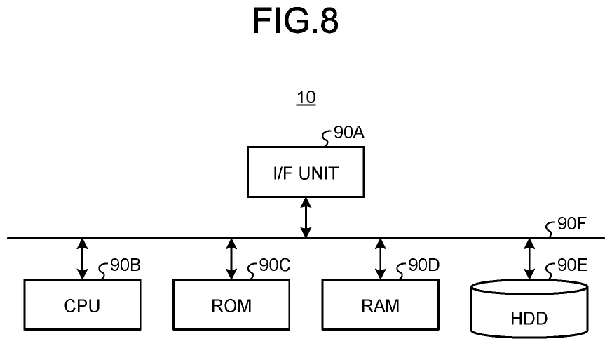

FIG. 8 is a hardware configuration diagram of an example of the machine learning device 10 of the foregoing embodiment.

The machine learning device 10 of the foregoing embodiment has a hardware configuration using a general computer, including a control device such as a central processing unit (CPU) 90B, a storage device such as a read-only memory (ROM) 90C, a random-access memory (RAM) 90D, and a hard disk drive (HDD) 90E, an I/F unit 90A that is an interface to various devices, and a bus 90F connecting the units.

In the machine learning device 10 of the foregoing embodiment, the CPU 90B reads a computer program from the ROM 90C into the RAM 90D and executes the computer program to implement the above modules on the computer.

A computer program for causing the above processes to be performed in the machine learning device 10 of the foregoing embodiment may be stored in the HDD 90E. The computer program for causing the above processes to be performed in the machine learning device 10 of the foregoing embodiment may be embedded in the ROM 90C in advance.

The computer program for causing the above processes to be performed in the machine learning device 10 of the foregoing embodiment may be stored in a computer-readable storage medium such as a CD-ROM, a CD-R, a memory card, a digital versatile disc (DVD), and a flexible disk (FD) in the form of a file in an installable format or an executable format and provided as a computer program product. The computer program for causing the above processes to be performed in the machine learning device 10 of the foregoing embodiment may be stored in a computer connected to a network such as the Internet and downloaded via the network. The computer program for causing the above processes to be performed in the machine learning device 10 of the foregoing embodiment may be provided or distributed via a network such as the Internet.

While certain embodiments have been described, these embodiments have been presented by way of example only, and are not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A machine learning device comprising:
an acquisition module configured to acquire observation information including information on a speed of a control target point at a control target time;
a first calculation module configured to calculate a reward for the observation information;
a second calculation module configured to calculate a corrected discount rate obtained by correcting a discount rate of the reward in accordance with a travel distance of the control target point represented by the observation information;
a learning module configured to learn a control policy by reinforcement learning from the observation information, the reward, and the corrected discount rate; and
an output module configured to output control information including information on speed control of the control target point that is determined in accordance with the observation information and the control policy.

2. The device according to claim 1, wherein the learning module learns the control policy, based on experience data in which at least the corrected discount rate and the reward are associated with each other.

3. The device according to claim 1, wherein the second calculation module is configured to calculate, as the corrected discount rate, a power of the discount rate with the travel distance as an exponent of the power.

4. The device according to claim 1, wherein the first calculation module is configured to calculate a first error between the control target point and a target trajectory using information on a position of the control target point included in the observation information and calculate the reward higher as the first error is smaller.

5. The device according to claim 4, wherein the first calculation module is configured to
set an error calculation target position to a position away from a position of the control target point represented by the observation information by a certain distance or more or a certain time period or more along a trajectory of the control target point, and
calculate, as the first error, a second error between the target trajectory and the error calculation target position.

6. The device according to claim 5, wherein the first calculation module is configured to set the error calculation target position to a position away from a position of the control target point represented by the observation information by the certain distance or more or the certain time period, input of which has been accepted, along a trajectory of the control target point.

7. The device according to claim 1, wherein the second calculation module is configured to calculate the corrected discount rate obtained by correcting the discount rate in accordance with an input corrected discount rate for an input travel distance, input of which has been accepted, in accordance with the travel distance.

8. The device according to claim 1, further comprising a display control module configured to display correspondence information indicating a correspondence between the corrected discount rate and the travel distance.

9. A machine learning method comprising:
acquiring observation information including information on a speed of a control target point at a control target time;
first calculating a reward for the observation information;
second calculating a corrected discount rate obtained by correcting a discount rate of the reward in accordance with a travel distance of the control target point represented by the observation information;
learning a control policy by reinforcement learning from the observation information, the reward, and the corrected discount rate; and
outputting control information including information on speed control of the control target point that is determined in accordance with the observation information and the control policy.

10. The method according to claim 9, wherein the learning includes learning the control policy based on experience data in which at least the corrected discount rate and the reward are associated with each other.

11. The method according to claim 9, wherein the second calculating includes calculating, as the corrected discount rate, a power of the discount rate with the travel distance as an exponent of the power.

12. The method according to claim 9, wherein the first calculating includes calculating a first error between the control target point and a target trajectory using information on a position of the control target point included in the observation information, and calculating the reward higher as the first error is smaller.

13. The method according to claim 12, wherein the first calculating includes
setting an error calculation target position to a position away from a position of the control target point represented by the observation information by a certain distance or more or by a certain time period or more along a trajectory of the control target point, and
calculating, as the first error, a second error between the target trajectory and the error calculation target position.

14. The method according to claim 13, wherein the first calculating includes setting the error calculation target position to a position away from a position of the control target point represented by the observation information by the certain distance or more or the certain time period or more, input of which has been accepted, along a trajectory of the control target point.

15. The method according to claim 9, wherein the second calculating includes calculating the corrected discount rate obtained by correcting the discount rate in accordance with an input corrected discount rate for an input travel distance, input of which has been accepted, in accordance with the travel distance.

16. The method according to claim 9, further comprising displaying correspondence information indicating a correspondence between the corrected discount rate and the travel distance.

17. A computer program product comprising a computer-readable medium including programmed instructions, the instructions causing a computer to perform:
acquiring observation information including information on a speed of a control target point at a control target time;
first calculating a reward for the observation information;
second calculating a corrected discount rate obtained by correcting a discount rate of the reward in accordance with a travel distance of the control target point represented by the observation information;
learning a control policy by reinforcement learning from the observation information, the reward, and the corrected discount rate; and
outputting control information including information on speed control of the control target point that is determined in accordance with the observation information and the control policy.

18. The computer program product according to claim 17, wherein the learning includes learning the control policy based on experience data in which at least the corrected discount rate and the reward are associated with each other.

19. The computer program product according to claim 17, wherein the second calculating includes calculating, as the corrected discount rate, a power of the discount rate with the travel distance as an exponent of the power.

20. The computer program product according to claim 17, wherein the first calculating includes calculating a first error between the control target point and a target trajectory using information on a position of the control target point included in the observation information, and calculating the reward higher as the first error is smaller.

21. The computer program product according to claim 20, wherein the first calculating includes
setting an error calculation target position to a position away from a position of the control target point represented by the observation information by a certain distance or more or a certain time period or more along a trajectory of the control target point, and
calculating, as the first error, a second error between the target trajectory and the error calculation target position.

22. The computer program product according to claim 21, wherein the first calculating includes setting the error calculation target position to a position away from a position of the control target point represented by the observation information by the certain distance or more or the certain time period or more, input of which has been accepted, along a trajectory of the control target point.

23. The computer program product according to claim 17, wherein the second calculating includes calculating the corrected discount rate obtained by correcting the discount rate in accordance with an input corrected discount rate for an input travel distance, input of which has been accepted, in accordance with the travel distance.

24. The computer program product according to claim 17, wherein the instructions cause the computer to further perform displaying correspondence information indicating a correspondence between the corrected discount rate and the travel distance.
